(19) United States
(12) Patent Application Publication
(10) Pub. No.: US 2007/0073679 A1
(43) Pub. Date: Mar. 29, 2007

(54) SYSTEM AND METHOD FOR GENERATING A BILL OF MATERIAL FILE

(76) Inventors: Chang-Wen Fu, Shenzhen (CN); Ge-Xin Zeng, Shenzhen (CN); De-Sheng Qiu, Shenzhen (CN); Hui-Zhang Wang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,173

(22) Filed: Jul. 6, 2006

(30) Foreign Application Priority Data
Aug. 26, 2005 (CN) 200510036845.7

(51) Int. Cl. G06F 17/30

(52) U.S. Cl. 707/5

(57) ABSTRACT

An exemplary method for generating a BOM file is disclosed. The method includes the steps of: extracting data on components of a circuit design diagram of a motherboard, and storing the data in an spreadsheet as a non-standardized original BOM file; determining whether the data meet requirements corresponding to designing standards of the motherboard by checking the data of the non-standardized original BOM file; classifying the data into lists according to predefined manufacturing procedures; and automatically generating a standardized BOM file according to the corresponding lists. A related system is also disclosed.

### FIELD OF THE INVENTION

The present invention is generally related to a system and method for generating a bill of material (BOM) file.

### DESCRIPTION OF RELATED ART

The process of designing, developing, and manufacturing a new product, or making major changes to existing products, presents many challenges to produce with the least cost, within a tight time schedule, all the while maintaining product quality. In today's highly competitive industries, product managers and engineers require information to address many problems that arise because of the complexity of worldwide manufacturing and the changing nature of competition. Because new products need to be put into the market in a very short time period to compete with other competitors, the traditional technology know-how advantages formerly associated with product development has disappeared, creating the need to better control product release and determine cost impacts of designs early in the design process.

To meet these needs, many companies are realizing that the conventional product design process is not satisfactory. They require early involvement of manufacturing engineering; cost engineering, logistics planning, procurement, manufacturing, and service/support with the design effort. In addition, they require planning and control of product data through the steps of design, release, and manufacture.

The OrCAD software as a circuit designing tool, can be very helpful for designing a printed circuit board (PCB). It outputs a non-standardized bill of material (BOM) to the engineer, manufacturer, and product manager, however, the format of the non-standardized BOM cannot meet the demands of manufacturing. A user must first process the non-standardized BOM before manufacturing. The manufacturer must find a reference for the relationship of each component in the non-standardized BOM from a pick file, and manually inputs the relationship of each component into the non-standardized BOM to generate a standardized BOM. This manner of generating the standardized BOM cannot quite meet the scheduling demands of manufacturing PCB, as it is a time-consuming, high cost process.

Therefore, what is needed is a system and method for generating a BOM, which can automatically generate a standardized BOM file by utilizing configure information of a PCB in time, so as to meet the demands of manufacturing PCB and reduce the cost on manufacturing PCB.

### SUMMARY OF THE INVENTION

A system for generating a bill of material (BOM) file is disclosed. The system includes an extracting module, a checking module, a processing module and a generating module. The extracting module is configured for extracting data on components of a circuit design diagram of a motherboard, and for storing the data in a spreadsheet as a non-standardized original BOM file. The checking module is configured for determining whether the data meet requirements corresponding to designing standards of the motherboard by checking the data of the non-standardized original BOM file. The processing module is configured for classifying the data into lists according to predefined manufacturing procedures. The generating module is configured for automatically generating a standardized BOM file according to the corresponding lists.

A method for generating a BOM file is disclosed. The method includes the steps of: extracting data on components of a circuit design diagram of a motherboard, and storing the data in an spreadsheet as a non-standardized original BOM file; determining whether the data meet requirements corresponding to designing standards of the motherboard by checking the data of the non-standardized original BOM file; classifying the data into lists according to predefined manufacturing procedures; and automatically generating a standardized BOM file according to the corresponding lists.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of a system for generating a bill of material (BOM) file in accordance with one embodiment;

FIG. 2 is a schematic diagram of items of a non-standardized original BOM file in FIG. 1;

FIG. 3 is a schematic diagram of items of a standardized BOM file in FIG. 1; and

FIG. 4 is a flowchart of a preferred method for generating a BOM file by utilizing the system of FIG. 1 in accordance with one embodiment.

### DETAILED DESCRIPTION OF THE INVENTION

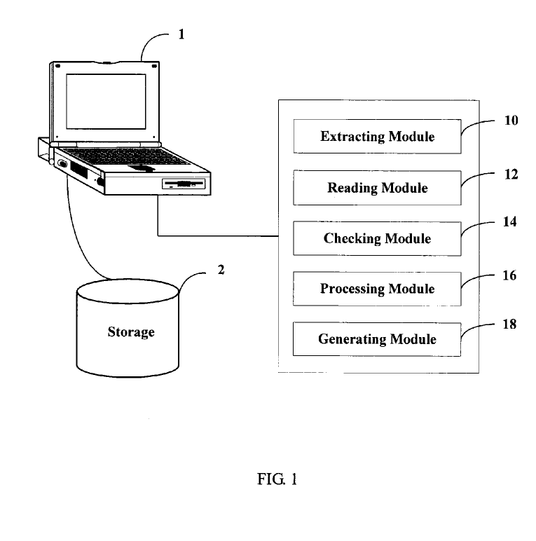

FIG. 1 is a schematic diagram of a system for generating a bill of material (BOM) file (hereinafter, “the system”) in accordance with one embodiment. The system typically includes a computer 1 and storage 2. The storage 2 is connected with the computer 1, and is used for storing data generated by utilizing the system, such as circuit design diagrams of various motherboards, non-standardized original BOMs of motherboards, standardized BOMs of motherboards, and so on. The computer 1 typically includes a plurality of units known in the art, such as a central processing unit (CPU) and a memory (not shown in FIG. 1), for transforming a non-standardized original BOM file into a standardized BOM file. In the preferred embodiment, the computer 1 further includes an extracting module 10, a reading module 12, a checking module 14, a processing module 16, and a generating module 18.

The extracting module 10 is configured for extracting attribute data on components of a circuit design diagram of a motherboard that is stored in the storage 2, and for storing the attribute data extracted in a spreadsheet as a non-standardized original BOM file. The spreadsheet can be an accounting or bookkeeping program installed in the computer 1, such as Microsoft Excel. The reading module 12 is configured for reading the attribute data extracted out of the non-standardized original BOM file and a pick file that is stored in the computer 1. The pick file typically stores location information on all components of a double-sided motherboard.

The checking module 14 is configured for determining whether the attribute data extracted meet requirements corresponding to designing standards of the motherboard by way of checking the attribute data extracted out of the non-standardized original BOM file. If the attribute data extracted meet requirements corresponding to designing standards of the motherboard, the checking module 14 is further configured for determining whether the motherboard is a single-sided motherboard or the double-sided motherboard.

The processing module 16 is configured for classifying the attribute data extracted into several lists according to predefined manufacturing procedures, if the attribute data extracted out of the non-standardized original BOM file meet requirements corresponding to designing standards of the motherboard. The predefined manufacturing procedures relate to surface mount parts, plated-through-hole (PTH) parts, and package parts. For example, if the motherboard is the single-sided motherboard, the processing module 16 classifies the extracted data into five lists that include: a first list named surface mount device (SMD) list for storing surface mount parts data, a second list named PTH list for storing PTH parts data, a third list named packing list for storing package parts data, a fourth list named dummy list for storing non-functional parts data, and a fifth list named material changed list for storing changed components data.

The generating module 18 is configured for inserting related data of the components into the corresponding lists, and generating the standardized BOM file according to the lists.

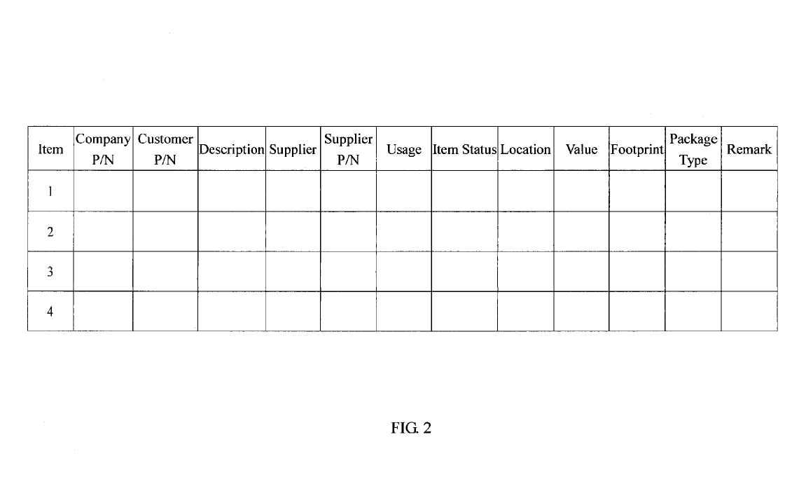

FIG. 2 is a schematic diagram of items of the non-standardized original BOM file. In the preferred embodiment, the items of the non-standardized original BOM file may include: “company component number (P/N),” “customer P/N,” “description,” “supplier,” “supplier P/N,” “usage,” “item status,” “location,” “value,” “footprint,” “package,” and “remark.” Each item stores corresponding attribute data extracted corresponding to components of the motherboard.

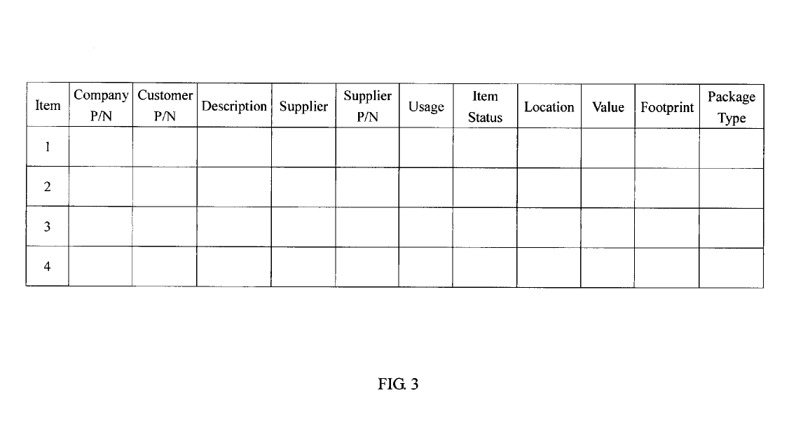

FIG. 3 is a schematic diagram of items of the standardized BOM file. In the preferred embodiment, the items of the standard BOM files may include: “company P/N,” “customer P/N,” “description,” “supplier,” “supplier P/N,” “usage,” “item status,” “location,” “value,” “footprint,” and “package.” Each item stores corresponding transformed data corresponding components of the motherboard.

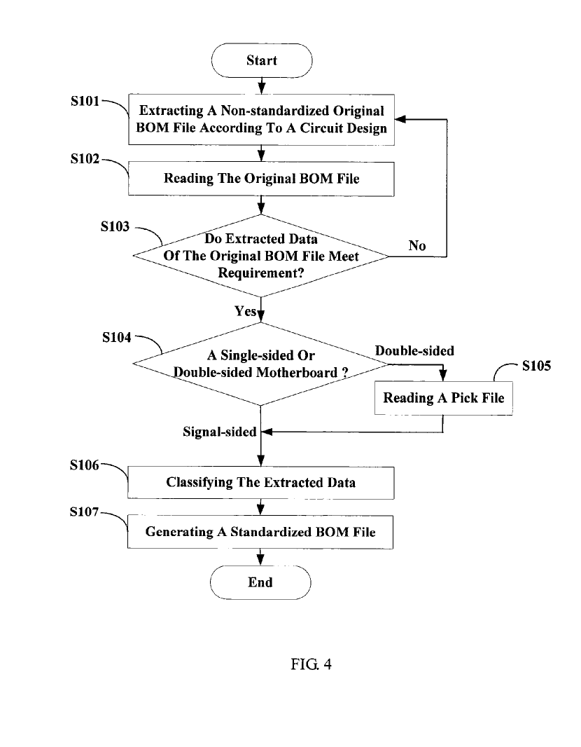

FIG. 4 is a flowchart of a preferred method for generating the BOM file by utilizing the system in accordance with one embodiment. In step S101, the extracting module 10 extracts the attribute data on components of the circuit design diagram of the motherboard stored in the storage 2, and stores the attribute data extracted in a spreadsheet as the non-standardized original BOM file.

In step S102, the reading module 12 reads the attribute data extracted out of the non-standardized original BOM file. In step S103, the checking module 14 determines whether the attribute data extracted meet requirements corresponding to designing standards of the motherboard by way of checking the attribute data extracted. If the attribute data extracted does not meet requirements corresponding to designing standards of the motherboard, the circuit design diagram needs to be modified, the process returns to step S101 described above.

Otherwise, if the attribute data extracted meet requirements corresponding to designing standards of the motherboard, in step S104, the checking module 14 determines whether the motherboard is the single-sided motherboard or the double-sided motherboard.

If the motherboard is the double-sided motherboard, in step S105, the reading module 12 reads the pick file, and the process goes directly to step S106 described below. The pick file typically stores the location information of the attribute data extracted corresponding to all components of the double-sided motherboard.

In step S106, the processing module 16 classifies the attribute data extracted out of the non-standardized BOM file into several lists according to predefined manufacturing procedures. The predefined manufacturing procedures relates to the surface mount parts, the PTH parts, and the package parts.

It is to be understood that, in step S106, if the motherboard is the single-sided motherboard the processing module 16 classifies the extracted data into five lists that includes: the first list named SMD list for storing surface mount parts data, the second list named PTH list for storing through-hole parts data, the third list named packing list for storing the package parts data, the fourth list named dummy list for storing the non-functional parts data, and the fifth list named material changed list for storing changed components data.

It is to be understood that, in step S106, if the motherboard is the double-sided motherboard, the processing module 16 classifies the extracted data into six lists that include: a first list named SMD top list for storing surface mount devices data on a top side of the motherboard, a second list named SMD bottom list for storing surface mount devices data on a bottom side of the motherboard, and a third list named PTH, a fourth list named packing list, a fifth list named dummy list and a sixth named material changed list regarding changed components data.

In step S107, the generating module 18 importing the data on components into the corresponding lists, and generates the standardized BOM file according to the corresponding lists.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for generating a bill of material (BOM) file, the system comprising:
an extracting module configured for extracting data on components of a circuit design diagram of a motherboard, and for storing the data in a spreadsheet as a non-standardized original BOM file;
a checking module configured for determining whether the data meet requirements corresponding to designing standards of the motherboard by checking the data of the non-standardized original BOM file;
a processing module configured for classifying the data into lists according to predefined manufacturing procedures; and
a generating module configured for automatically generating a standardized BOM file according to the corresponding lists.

2. The system according to claim 1, wherein the checking module is further configured for determining whether the motherboard is a single-sided motherboard or a double-sided motherboard.

3. The system according to claim 2, further comprising a reading module configured for reading a pick file if the motherboard is a double-sided motherboard.

4. The system according to claim 3, wherein the pick file stores location information of all components of the double-sided motherboard.

5. The system according to claim 3, wherein the standardized BOM file is either the standardized BOM file of the single-sided motherboard or the standardized BOM file of the double-sided motherboard.

6. The system according to claim 1, wherein the predefined manufacturing procedures are selected from a group consisting of the manufacturing procedures related to surface mount parts, plated-through-hole parts, and package parts.

7. The system according to claim 6, wherein the lists of the standardized BOM file of the single-sided motherboard comprises: a first list for storing surface mount parts data, a second list for storing plated-through-hole parts data, a third list for storing package parts data, a fourth list for storing non-functional parts data, and a fifth list for storing changed components data.

8. The system according to claim 6, wherein the lists of the standardized BOM file of the double sided motherboard comprises: a first list for storing surface mount parts data on a top side of the motherboard, a second list for storing surface mount parts data on a bottom side of the motherboard, a third list for storing plated-through-hole parts data, a fourth list for storing package parts data, a fifth list for storing non-functional parts data, and a sixth list for storing changed components data.

9. A method for generating a bill of material (BOM) file, the method comprising the steps of:
extracting data on components of a circuit design diagram of a motherboard, and storing the data in an spreadsheet as a non-standardized original BOM file;
determining whether the data meet requirements corresponding to designing standards of the motherboard by checking the data of the non-standardized original BOM file;
classifying the data into lists according to predefined manufacturing procedures; and
automatically generating a standardized BOM file according to the corresponding lists.

10. The method according to 9, further comprising steps of:
determining whether the motherboard is a single-sided motherboard or a double-sided motherboard, if the data meet the requirements corresponding to designing standards of the motherboard; and
reading a pick file if the motherboard is a double-sided motherboard.

11. The method according to 10, wherein the pick file is configured for storing location information on all components of the double-sided motherboard.

12. The method according to 11, wherein the standardized BOM file is either the standardized BOM file of the single-sided motherboard or the standardized BOM file of the double-sided motherboard.

13. The method according to claim 9, wherein the predefined manufacturing procedures are selected from a group consisting of the manufacturing procedures related to surface mount parts, plated through hole parts, and package parts.

14. The method according to claim 13, wherein the lists of the standardized BOM file of the single-sided motherboard comprises: a first list for storing surface mount parts data, a second list for storing plated-through-hole parts data, a third list for storing package parts data, a fourth list for storing non-functional parts data, and a fifth for storing changed components data.

15. The method according to claim 13, wherein the lists of the standardized BOM file of the double sided motherboard comprises: a first list for storing surface mount parts data on a top side of the motherboard, a second list for storing surface mount parts data on a bottom side of the motherboard, a third list for storing plated-through-hole parts data, a fourth list for storing package parts data, a fifth list for storing non-functional parts data, and a sixth list for storing changed components data.
